(19) United States
(12) Patent Application Publication
(10) Pub. No.: US 2026/0235747 A1
(43) Pub. Date: Aug. 13, 2026

(54) METHOD AND DEVICE WITH RADAR SIGNAL PROCESSING

(71) Applicant: Samsung Electronics Co., Ltd., Suwon-si (KR)

(72) Inventors: Seung Tae KHANG, Suwon-si (KR); Ghoo KIM, Suwon-si (KR); Jong-Sok KIM, Suwon-si (KR)

(73) Assignee: Samsung Electronics Co., Ltd., Suwon-si (KR)

(21) Appl. No.: 19/287,594

(22) Filed: Jul. 31, 2025

(30) Foreign Application Priority Data
Feb. 12, 2025 (KR) 10-2025-0018109

(51) Int. Cl. G01S 13/42; G01S 13/931

(52) U.S. Cl. CPC G01S 13/42; G01S 13/931

(57) ABSTRACT

A method performed by an electronic device according to an embodiment, includes determining a target point based on a radar signal, determining a first angle set for the target point by using a first array in a virtual MIMO array and determining a second angle set for the target point by using a second array in the virtual MIMO array, generating angle pairs respectively including a corrected first angle and a corrected second angle, determining a matching score for each of the angle pairs by using a third array corresponding to a portion of the virtual MIMO array, and generating multi-angle information of the target point based on target angle pairs, among the angle pairs, of which corresponding matching scores satisfy a predetermined criterion.

### CROSS-REFERENCE TO RELATED APPLICATIONS

This application claims the benefit under 35 USC § 119(a) of Korean Patent Application No. 10-2025-0018109, filed on Feb. 12, 2025, in the Korean Intellectual Property Office, the entire disclosure of which is incorporated herein by reference for all purposes.

### BACKGROUND

### 1. Field

The following embodiments relate to a method and device with radar signal processing.

### 2. Description of Related Art

Advanced driver assistance systems (ADAS) support driving by using sensors installed inside or outside a vehicle to improve driver safety and convenience and to avoid dangerous situations. Sensors used in ADAS may include cameras, infrared sensors, ultrasonic sensors, LiDAR, and radar.

In particular, there is increasing demand for an ADAS capable of recognizing and tracking objects in autonomous vehicles, security monitoring devices, and the like. In autonomous vehicles, the shape of the surroundings may be expressed as a point cloud through information collected by radar or LiDAR sensors.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method performed by an electronic device includes: determining a target point based on a radar signal of an antenna array included in a radar sensor; determining a first angle set of first angles for the target point by using a first array arranged in a first dimension in a virtual multi-input multi-output (MIMO) array implemented by the antenna array, and determining a second angle set of second angles for the target point by using a second array arranged in a second dimension in the virtual MIMO array, the second dimension orthogonal to the first dimension; generating angle pairs each including a corrected first angle and a corrected second angle, by performing a sinusoidal operation on each of combinations between the first angles and the second angles; determining matching scores of the respective angle pairs by using a third array that is a portion of the virtual MIMO array, the third array comprising virtual antenna elements arranged in two dimensions; and generating multi-angle information of the target point based on target angle pairs selected, from among the angle pairs, based on having matching scores that satisfy a criterion.

The determined target points may each include distance information and velocity information determined by performing a range fast Fourier transform (FFT) and a doppler FFT based on the radar signal.

The first angle set may be determined by performing a one-dimensional direction of arrival (DOA) estimation based on a radar signal of the first array, and wherein the second angle set may be determined by performing a one-dimensional DOA estimation based on a radar signal of the second array.

Each of the first angles may be an azimuth, and each of the second angles may be an elevation.

The determining of the matching score for each of the angle pairs may include: generating a spherical angle pair of a corresponding angle pair by using the corrected first angle and the corrected second angle included in the corresponding angle pair, wherein the spherical angle pair includes a third angle and a fourth angle of a spherical coordinate system; and determining the matching score for the corresponding spherical angle pair based on a radar signal of the third array.

The third angle be a colatitude, and the fourth angle may be a longitude.

The matching score for the corresponding spherical angle pair may be calculated using a radar signal received via the virtual antenna elements of the third array, relative positions of the virtual antenna elements of the third array, and the third angle and the fourth angle included in the corresponding spherical angle pair.

The generating of the multi-angle information of the target point may include: based on the number of first angles being greater than the number of second angles, for angle pair subsets respectively corresponding to the first angles, selecting as the target angle pairs the angle pair in each angle pair subset that has the highest matching score therein, wherein each angle pair subset includes angle pairs of the corresponding first angle paired with each of the second angles.

The generating of the multi-angle information of the target point may include: based on the number of first angles being less than the number of second angles, for angle pair subsets respectively corresponding to the second angles, selecting as the target angle pairs the angle pair in each angle pair subset that has the highest matching score therein, wherein each angle pair subset includes angle pairs of the corresponding second angle paired with each of the first angles.

The electronic device may be included in a vehicle.

In another general aspect, a non-transitory computer-readable storage medium stores instructions, and the instructions, when executed by one or more processors of an electronic device, cause the electronic device to: determine a target point based on a radar signal of an antenna array included in a radar sensor; determine a first angle set of first angles for the target point by using a first array arranged in a first dimension in a virtual MIMO array implemented by the antenna array, and determine a second angle set of second angles for the target point by using a second array arranged in a second dimension in the virtual MIMO array, the second dimension orthogonal to the first dimension; generate angle pairs each including a corrected first angle and a corrected second angle, by performing an operation on each of combinations between the first angles and the second angles; determine matching scores of the respective angle pairs by using a third array that is a portion of the virtual MIMO array, the third array comprising virtual antenna elements arranged in two dimensions; and generate multi-angle information of the target point based on target angle pairs selected, from among the angle pairs, based on having matching scores that satisfy a criterion.

In another general aspect, an electronic device includes: one or more processors; and memory including one or more storage media storing instructions that, when executed by the one or more processors, cause the electronic device to: determine a target point based on a radar signal of an antenna array included in a radar sensor; determine a first angle set of first angles for the target point by using a first array arranged in a first dimension in a virtual MIMO array implemented by the antenna array, and determine a second angle set of second angles for the target point by using a second array arranged in a second dimension in the virtual MIMO array, the second dimension orthogonal to the first dimension; generate angle pairs each including a corrected first angle and a corrected second angle, by performing an operation on each of combinations between the first angles and the second angles; determine matching scores of the respective angle pairs by using a third array that is a portion of the virtual MIMO array, the third array comprising virtual antenna elements arranged in two dimensions; and generate multi-angle information of the target point based on target angle pairs selected, from among the angle pairs, based on having matching scores that satisfy a criterion.

The determined target point may include distance information and velocity information determined by performing a range FFT and a doppler FFT based on the radar signal.

The first angle set may be determined by performing a one-dimensional DOA estimation based on a radar signal of the first array, and the second angle set may be determined by performing a one-dimensional DOA estimation based on a radar signal of the second array.

Each of the first angles may be an azimuth, and each of the second angles may be an elevation.

The determining of the matching score for each of the angle pairs may include: generating a spherical angle pair of a corresponding angle pair by using the corrected first angle and the corrected second angle included in the corresponding angle pair, wherein the spherical angle pair includes a third angle and a fourth angle of a spherical coordinate system; and determining the matching score for the corresponding spherical angle pair based on a radar signal of the third array.

The third angle may be a colatitude, and the fourth angle may be a longitude.

The matching score for the corresponding spherical angle pair is calculated using a radar signal received via the virtual antenna elements of the third array, relative positions of the virtual antenna elements of the third array, and the third angle and the fourth angle included in the corresponding spherical angle pair.

The corrected first angle and the corrected second angle of each angle pair may be determined based the corresponding paired first angle and second angle.

A sinusoidal operation may be performed on the first angle and the second angle to obtain the corrected first angle and the corrected second angle.

Other features and aspects will be apparent from the following detailed description, the drawings, and the claims.

### BRIEF DESCRIPTION OF THE DRAWINGS

FIG. 1 illustrates an example of a method of recognizing a surrounding environment through radar signal processing, according to one or more embodiments.

FIG. 2 illustrates an example of an electronic device according to one or more embodiments.

FIG. 3 illustrates an example of a virtual multiple-input and multiple-output (MIMO) array according to one or more embodiments.

FIG. 4 illustrates an example of a virtual MIMO array according to one or more embodiments.

FIG. 5 illustrates an example of a radar signal processing method according to one or more embodiments.

FIG. 6 illustrates an example of a method of determining a matching score of angle pairs, according to one or more embodiments.

FIG. 7 illustrates an example of a method of generating multi-angle information of a target point, according to one or more embodiments.

FIG. 8 illustrates an example of a direction of a target point with respect to a coordinate system based on a radar antenna side, according to one or more embodiments.

FIG. 9 illustrates an example of generated multi-angle information, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

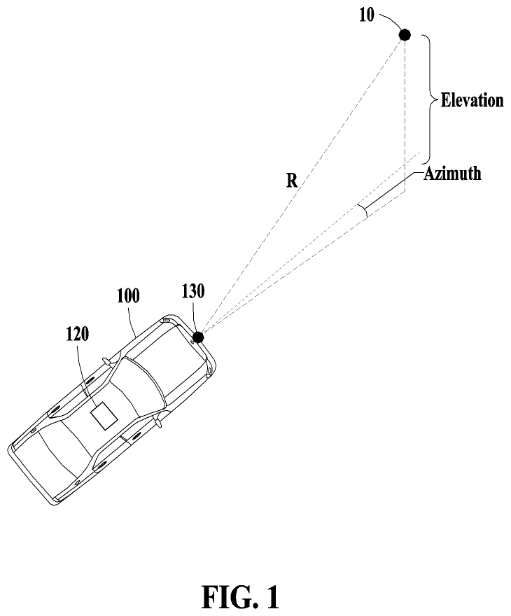

FIG. 1 illustrates an example of a method of recognizing a surrounding environment through radar signal processing, according to one or more embodiments.

An electronic device 120 for processing a radar signal may detect information (e.g., a range, velocity, or direction) on an object (e.g., object 10) outside the electronic device 120 by analyzing a radar signal received from a radar sensor 130.

Referring to FIG. 1, a vehicle 100 may detect the information on the object 10 outside the vehicle 100 by analyzing a radar signal received from the radar sensor 130. The vehicle 100 may include the electronic device 120 for processing a radar signal received from the radar sensor 130. The radar sensor 130 may be positioned inside or outside the electronic device 120. The electronic device 120 may detect the information on the object 10 by using data collected from other sensors (e.g., an image sensor) mounted on the vehicle 100 together with a radar signal received from the radar sensor 130.

The vehicle 100 may perform various advanced driving (AD) functions such as adaptive cruise control (ACC), autonomous emergency braking (AEB), blind spot detection (BSD), and/or lane change assistance (LCA), based on a range to the object 10 detected by the electronic device 120. The electronic device 120 may generate a surroundings map in addition to performing range detection. The surroundings map may represent positions of various objects (or areas indicating unknown information) around the electronic device 120 (or the vehicle 100), such as the object 10. Those objects may be dynamic objects, such as vehicles and people, or static objects, such as guardrails and traffic lights, in the background.

The electronic device 120 may detect target points regarding a static or dynamic object in the surrounding environment based on a radar signal received from the radar sensor 130. Each target point may include range information and velocity information.

The electronic device 120 may generate direction of arrival (DOA) information of the target points by analyzing a radar signal received from the radar sensor 130. The DOA information may represent information indicating a direction (heading) in which a radar signal reflected from a target point corresponding to the object 10 is received. The electronic device 120 may identify a direction in which the target point corresponding to the object 10 exists relative to the radar sensor 130 by using the DOA information. The DOA information may be used to generate radar scan data and the surrounding map.

The electronic device 120 may generate point cloud data about the surrounding environment by using the DOA information of the target points. The point cloud data may be used to control the vehicle 100 equipped with the electronic device 120. For example, the control of the vehicle 100 may include velocity and/or steering control, such as ACC, AEB, BSD, or LCA, of the vehicle 100. A control system of the vehicle 100 may control the vehicle 100 by directly or indirectly using the point cloud data.

The DOA information of a target point may include a horizontal angle and/or a vertical angle between a traveling direction of the electronic device 120 and a target direction from the electronic device 120 (or the radar sensor 130) to the target point. Here, the traveling direction of the electronic device 120 may include a traveling direction of the vehicle 100 including the radar sensor 130 or the electronic device 120.

The DOA information of a target point may include an azimuth (or angle of azimuth) as a horizontal angle indicated by the target direction. The DOA information of a target point may additionally or alternatively include an elevation (or angle of elevation) as a vertical angle indicated by the target direction. For example, the electronic device 120 may detect a range, velocity, and a direction including an azimuth and elevation with respect to a target point through four-dimensional (4D) radar signal processing.

The target point detected based on the radar signal may include, for example, a radar signal from multiple angles when the radar sensor 130 has a relatively high angular resolution. Accordingly, the electronic device 120 may determine multiple azimuths and multiple elevations for the target point by performing DOA estimation based on the radar signal received from the radar sensor 130.

The electronic device 120 may estimate (or determine) azimuths for a target point by performing one-dimensional DOA estimation in a horizontal direction based on a radar signal received from the radar sensor 130. The electronic device 120 may estimate (or determine) elevations for a target point by performing one-dimensional DOA estimation in a vertical direction based on a radar signal received from the radar sensor 130. The electronic device 120 may correct angular errors of azimuths and elevations determined respectively through one-dimensional DOA estimation.

The electronic device 120 may match/select an elevation (among the multiple elevations) that reflects an actual position of a target point at a given azimuth, and may do so based on a radar signal received from the radar sensor 130 for a predetermined azimuth relative to the target point. Alternatively or additionally, the electronic device 120 may, for a predetermined elevation relative to the target point, match/select a correct azimuth (among the multiple azimuths) that reflects the actual position of the target point at that elevation, and may do so based on the radar signal received from the radar sensor 130. The electronic device 120 may determine azimuth-elevation pairs for the target point by matching the estimated azimuths and elevations with respect to the target point. The electronic device may generate the azimuth-elevation pairs with respect to the target point, which may serve as multi-angle information of the target point.

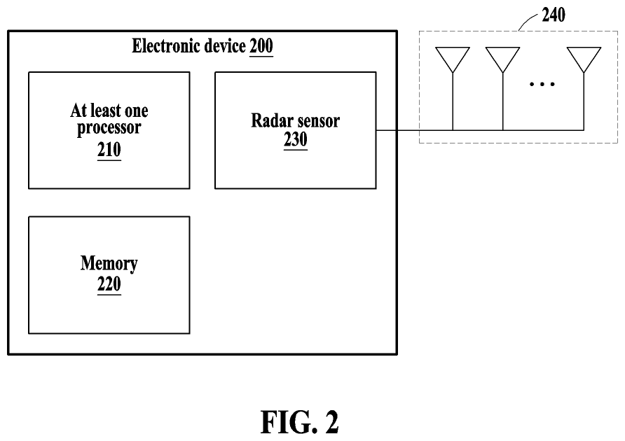

FIG. 2 illustrates an example of an electronic device according to one or more embodiments.

An electronic device 200 (e.g., the electronic device 120 of FIG. 1), according to an embodiment, may include at least one processor (hereafter, the processor) 210 including processing circuitry, a memory 220 including one or more storage media storing the instructions, and a radar sensor 230 (e.g., the radar sensor 130 of FIG. 1). When the instructions are individually or collectively executed by the processor 210, the instructions may cause the electronic device 200 to perform at least some of the operations described with reference to FIGS. 1 to 9 of the present disclosure. For example, the vehicle 100 of FIG. 1 may include the electronic device 200. As used herein, “vehicle” refers to any moveable object.

The electronic device 200 may include a communicator that is connected to the processor 210 and the memory 220 to transmit and receive data. The communicator may be connected to another external device and may transmit and receive data to and from the external device. Herein, transmitting and receiving “A” may refer to transmitting and receiving “information or data indicating A”.

The communicator may be implemented as circuitry in the electronic device 200. For example, the communicator may include an internal bus and an external bus. In another example, the communicator may be an element that connects the electronic device 200 to the external device. The communicator may be an interface (e.g., a network interface card). The communicator may receive data from the external device and may transmit the data to the processor 210 and the memory 220.

The processor 210 may process data received by the communicator, data stored in the memory 220, and radar signals received from the radar sensor 230. The “processor” may be a hardware-implemented data processing device having a physically structured circuit to execute desired operations. For example, the desired operations may include code or instructions included in a program. For example, the hardware-implemented data processing device may include a microprocessor, a central processing unit (CPU), a graphics processing unit (GPU), a processor core, a multi-core processor, a multiprocessor, an application-specific integrated circuit (ASIC), or a field-programmable gate array (FPGA), as non-limiting examples.

The processor 210 may control other components (e.g., hardware or software components) of the electronic device 200 and may perform various types of data processing or operations. As at least a part of data processing or operations, the processor 210 may store instructions or data received from another component (e.g., the communicator or the radar sensor 230) in at least a portion of the memory 220, may process the instructions or the data stored in the memory 220, and may store result data in the memory 220. The operations performed by the processor 210 may be substantially the same as the operations of the electronic device 200.

The memory 220 may store information necessary for the processor 210 to perform a processing operation. The memory 220 (or one or more storage media included in the memory 220) may store instructions executed by the processor 210 and may store related information while software or a program is executed by the electronic device 200. As non-limiting examples, the memory 220 may include one or more memories, which are volatile and/or non-volatile memories known in the field, such as random-access memory (RAM), dynamic RAM (DRAM), static RAM (SRAM), non-volatile RAM (NVRAM), persistent memory (PMEM), magneto-resistive RAM (MRAM), high bandwidth memory (HBM), or 3DXPoint.

The electronic device 200 may be connected to an external memory through the communicator. For example, the external memory may include one or more volatile memories, non-volatile memories and RAM, flash memories, hard disk drives, and optical disc drives. The external memory may store instructions (e.g., software) for operating the electronic device 200. The instruction set for operating the electronic device 200 may be executed by the processor 210.

The radar sensor 230 may radiate a radar signal to the outside of the radar sensor 230. The radiated radar signal may be reflected by an object (e.g., the object 10 of FIG. 1). The radar sensor 230 may receive the radar signal reflected by the object (e.g., the object 10 of FIG. 1).

The radar sensor 230 may include an antenna array 240. For example, the radar sensor 230 may represent a sensor circuit including the antenna array 240. The radar sensor 230 may transmit a radar signal through the antenna array 240. The radar sensor 230 may receive a radar signal through the antenna array 240.

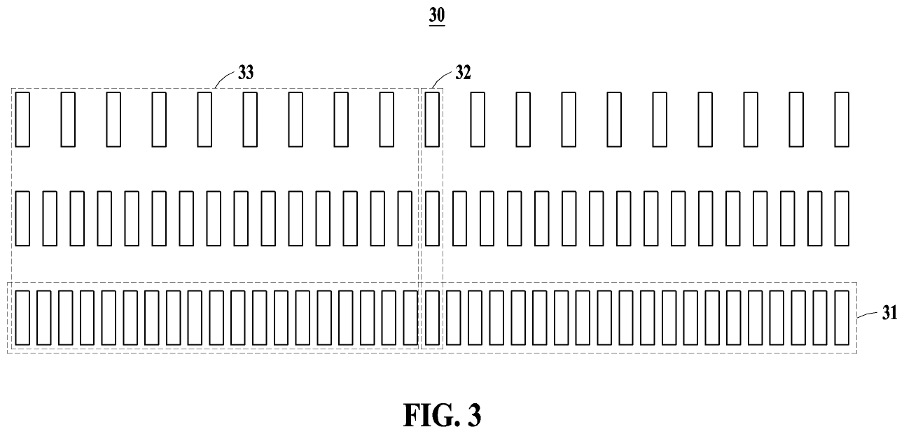

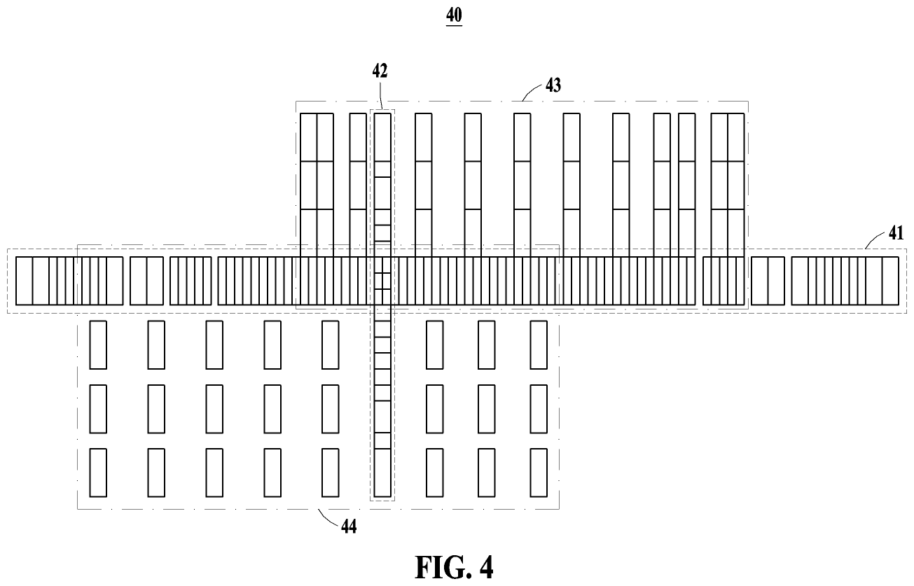

The antenna array 240 may include antenna elements. Multiple-input and multiple-output (MIMO) may be implemented through the antenna elements of the antenna array 240. A virtual MIMO implemented by the antenna array 240 is described with reference to FIGS. 3 and 4. As used herein, “antenna element” refers to physical antenna elements.

The processor 210 may generate object information on an object based on a radar signal of the antenna array 240 included in the radar sensor 230 and may use the generated object information. As non-limiting examples, the processor 210 may perform range fast Fourier transform (FFT), Doppler FFT, constant false alarm rate detection (CFAR), and/or DOA estimation, and may obtain the object information, such as a range, a velocity, and a direction, based on the radar signal. The object information may be provided for various applications, such as ACC, AEB, BSD, and LCA.

In some embodiments, the electronic device 200 is a component that manages an electronic system of a vehicle (e.g., the vehicle 100 of FIG. 1) and may represent an electronic control unit (ECU) of the vehicle, a component included in the electronic control unit, or a component directly (e.g., wired) or wirelessly connected to the electronic control unit.

FIG. 3 illustrates an example of a virtual MIMO array according to one or more embodiments. FIG. 4 illustrates an example of a virtual MIMO array according to one or more embodiments.

As described with reference to FIG. 2, the radar sensor 230 may include the antenna array 240. The antenna array 240 may include a plurality of antenna elements.

For 4D radar signal processing, the antenna array 240 may include transmitting antenna elements and receiving antenna elements. For example, when the antenna array 240 includes M transmitting antenna elements and N receiving antenna elements, channels corresponding to M×N virtual antennas (or virtual antenna elements) may be formed. Here, radar signals received through the respective channels may have different phases depending on a reception direction. M×N virtual antennas may form a virtual MIMO array.

Referring to FIG. 3, a virtual MIMO array (or, virtual MIMO configuration) 30 according to an embodiment may include a first array 31 arranged in one dimension, a second array 32 arranged in a dimension orthogonal to the dimension of the first array 31, and a third array 33 arranged in two dimensions corresponding to a portion of the virtual MIMO array 30. Other arrangements may be used.

The electronic device 200 may estimate an azimuth for a target point based on a radar signal received through the first array 31 arranged in a horizontal direction. The electronic device 200 may estimate an elevation (or elevation angle) for the target point based on a radar signal received through the second array 32 arranged in a vertical direction. The electronic device 200 may estimate multiple azimuths and multiple elevations, respectively, by performing one-dimensional DOA estimation based on the radar signal of the first array 31 and one-dimensional DOA estimation based on the radar signal of the second array 32.

The electronic device 200 may, for the target point, based on a radar signal received through the third array 33, match/select an elevation (among the elevations) that reflects an actual position of the target point at a corresponding azimuth for a predetermined azimuth with respect to the target point. Alternatively or additionally, the electronic device 200 may, for the target point, based on the radar signal received through the third array 33, match/select a correct azimuth (among the plurality of azimuths) that reflects an actual position of the target point at that elevation for a predetermined elevation relative to the target point.

The electronic device 200 may calculate a matching score between estimated azimuths and estimated elevations for the target point based on the radar signal received through the third array 33. That is, estimated azimuths and estimated elevations that match the signal of an ancillary array, e.g., the third array 333, may be selected to supplement the target point. The electronic device 200 may generate azimuth-elevation pairs for the target point determined based on the respective matching scores as multi-angle information of the target point.

Referring to FIG. 4, a virtual MIMO array (or, virtual MIMO configuration) 40 according to an embodiment may include a first array 41 arranged along a first dimension, a second array 42 arranged along a second dimension orthogonal to the first dimension of the first array 41. The virtual MIMO array may also include third arrays 43 and 44, each with individual virtual antennae elements in a rectilinear arrangement (e.g., a matrix configuration) with two dimensions corresponding to the first and second dimensions of the first and second arrays 41, 42. The rows and/or columns of third arrays 43 and 44 may be arranged at regular or irregular intervals.

The electronic device 200 may estimate an azimuth for a target point based on a radar signal received through the first array 41 arranged in a horizontal direction. The electronic device 200 may estimate an elevation (or elevation angle) for the target point based on a radar signal received through the second array 42 arranged in a vertical direction. The electronic device 200 may estimate multiple azimuths and multiple elevations, respectively, by performing one-dimensional DOA estimation based on the radar signal of the first array 41 and one-dimensional DOA estimation based on the radar signal of the second array 42.

The electronic device 200 may, based on a radar signal received through the third arrays 43 and 44, match (or select) (i) an elevation (among the multiple elevations from the second array 42), that will reflect an actual position of the target point at a corresponding azimuth among the plurality of elevations for a predetermined azimuth with respect to the target point. Alternatively or additionally, the electronic device 200 may, based on the radar signal received through the third arrays 43 and 44, match a predetermined elevation relative to the target point with a correct azimuth (among the azimuths from the first array 41) that reflects an actual position of the target point at that elevation among the plurality of azimuths.

The electronic device 200 may calculate matching scores between estimated azimuths and estimated elevations (for the target point) based on the radar signal received through the third arrays 43 and 44. The electronic device 200 may generate azimuth-elevation pairs for the target point, where the azimuth-elevation pairs are determined based on the matching scores, and the pairs may serve as multi-angle information of the target point.

For example, the electronic device 200 may calculate matching scores of estimated azimuth-elevation pairs for the target point with respect to a radar signal received only through the third array 43 (a matching score may reflect “closeness” of an estimated azimuth-elevation to directional information based on the third array 43). For example, the electronic device 200 may calculate a matching scores of estimated azimuth-elevation pairs (for the target point) based on (with respect to) a radar signal received only through the third array 44. For example, the electronic device 200 may calculate a matching score between an estimated azimuth-elevation pair for the target point based on radar signals received through all of the third arrays 43 and 44.

The electronic device 200 may secure resolution when estimating an azimuth through the first array 31 or 41 arranged in the horizontal direction of the virtual MIMO array 30 or 40.

The electronic device 200 may secure resolution when estimating an elevation through the second array 32 or 42 arranged in the vertical direction of the virtual MIMO array 30 or 40.

The electronic device 200 may reduce the amount of computation required to generate angle information of a target point and increase speed by calculating a matching score based on radar signals of the third array 33, 43 and/or 44 corresponding to a portion, but not all, of the virtual MIMO array 30 or 40.

However, a position, size (or number of virtual antennas) or spacing between virtual antennas of the third array 33, 43, and/or 44 illustrated in FIGS. 3 and 4 are only examples, and the third array 33, 43, and/or 44 is not limited to the illustrated examples. For example, the accuracy of angular information may be improved when computing matching scores using more virtual antennas (or a two-dimensional array including more virtual antennas). On the other hand, when matching scores are computed using fewer virtual antennas, the computation speed of the angular information may be increased.

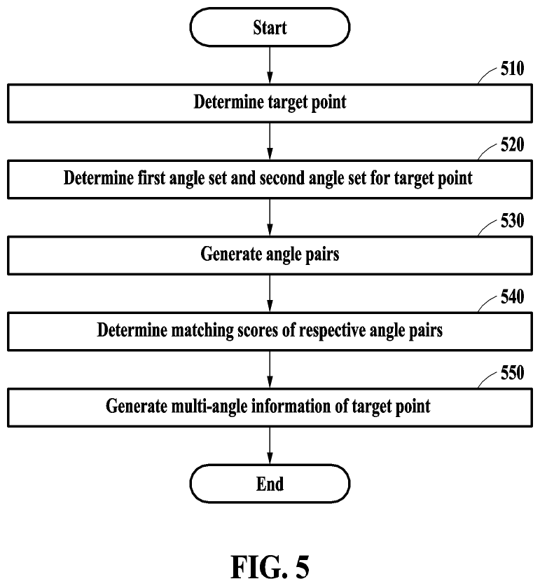

FIG. 5 illustrates an example of a radar signal processing method according to one or more embodiments.

Operations 510 to 550 described below may be performed by an electronic device (e.g., the electronic device 120 of FIG. 1 or the electronic device 200 of FIG. 2). The electronic device may include at least some of the components of the electronic device 120 or 200 described in FIGS. 1 and 2. For example, the electronic device may include at least one processor (e.g., the at least one processor 210 of FIG. 2). The electronic device may include a memory (e.g., the memory 220 of FIG. 2). The electronic device may include a radar sensor (e.g., the radar sensor 130 of FIG. 1 or the radar sensor 230 of FIG. 2). The radar sensor of the electronic device may include an antenna array (e.g., the antenna array 240 of FIG. 2).

In operation 510, the electronic device may determine a target point based on a radar signal of an antenna array included in the radar sensor.

The electronic device may determine the target point including range information and velocity information by performing range FFT and Doppler FFT based on the radar signal.

In operation 520, the electronic device may determine a first angle set (e.g., azimuth angles) for the target point by using a first array (e.g., the first array 31 of FIG. 3 or the first array 41 of FIG. 4) arranged in one dimension in a virtual MIMO array (e.g., the virtual MIMO array 30 of FIG. 3 or the virtual MIMO array 40 of FIG. 4) implemented by an antenna array included in the radar sensor. The electronic device may determine a second angle set (e.g., elevation angles) for the target point using a second array (e.g., the second array 32 of FIG. 3 or the second array 42 of FIG. 4) arranged in a dimension orthogonal to the dimension of the first array in the virtual MIMO array.

The electronic device may determine the first angle set by performing one-dimensional DOA estimation based on a radar signal (or a radar signal received through the first array) of the first array. The first angle set may include one or more first angles. Each of the first angles of the first angle set may be an azimuth.

The electronic device may determine the second angle set by performing one-dimensional DOA estimation based on a radar signal of the second array. The second angle set may include one or more second angles. Each of the second angles of the second angle set may be an elevation.

In operation 530, the electronic device may generate angle pairs, each including a corrected first angle and a corrected second angle, by performing a predetermined sinusoidal operation (described later) on each of the angle pairs formed by the possible combinations between the first angles (of the first angle set) and the second angles (of the second angle set).

A corrected first angle θ_{Azi} and a corrected second angle θ_{Elv}, both corrected through a predetermined sinusoidal operation applied to each of the angle pairs formed from on the combinations between the first angles and the second angles. An arbitrary/representative first angle θ_{Azi_1D} in the first angle set paired with an arbitrary/representative second angle θ_{Elv_1D} in the second angle set may each be used as expressed in Equation 1 and Equation 2, respectively to obtained respectively corresponding corrected angles θ_{Azi} and θ_{Elv}. Equations 1 and 2 may together be considered to be a predetermined sinusoidal operation, and, when applied to a given angle pair (along with Equation 3), the predetermined sinusoidal operation adjusts/corrects the angles of the arbitrary/representative angle pair.

$${θ}_{Azi} = sign ( {θ}_{AZI \_ 1 D} ) \times {tan}^{- 1} ( \sqrt{\frac{1 + \frac{{sin}^{2} {θ}_{Elv \_ 1 D}}{1 - {sin}^{2} {θ}_{Elv \_ 1 D}}}{\frac{1 - {sin}^{2} {θ}_{Azi \_ 1 D}}{{sin}^{2} {θ}_{Azi \_ 1 D}} - \frac{{sin}^{2} {θ}_{Elv \_ 1 D}}{1 - {sin}^{2} {θ}_{Elv \_ 1 D}}}} ) \qquad Equation 1$$

$${θ}_{Elv} = sign ( {θ}_{Elv \_ 1 D} ) \times {tan}^{- 1} ( \sqrt{\frac{1 + \frac{{sin}^{2} {θ}_{Azi \_ 1 D}}{1 - {sin}^{2} {θ}_{Azi \_ 1 D}}}{\frac{1 - {sin}^{2} {θ}_{Elv \_ 1 D}}{{sin}^{2} {θ}_{Elv \_ 1 D}} - \frac{{sin}^{2} {θ}_{Azi \_ 1 D}}{1 - {sin}^{2} {θ}_{Azi \_ 1 D}}}} ) \qquad Equation 2$$

In Equation 1 and Equation 2, sign(O) may be calculated using Equation 3.

$$sign ( θ ) = \{ \begin{matrix}1 , & for θ > 0 \\ 0 , & for θ = 0 \\ - 1 , & for θ < 0\end{matrix} \qquad Equation 3$$

The electronic device may perform the sinusoidal operation on a combination (or, an angle pair (θ_{Azi_1D},θ_{Elv_1D}) of the uncorrected first angle θ_{Azi_1D} and the uncorrected second angle θ_{Elv_1D} according to Equation 1 and Equation 2, to generate a corrected angle pair (θ_{Azi},θ_{Elv}) including the corrected first angle θ_{Azi} and the corrected second angle θ_{Elv}.

The electronic device may generate corrected angle pairs, each including a corrected first angle and a corrected second angle, by performing the sinusoidal operation according to Equation 1 and Equation 2 for all possible combinations (or angle pairs) between the uncorrected first angles of the first angle set and the uncorrected second angles of the second angle set. For example, when the first angle set includes a number “a” of first uncorrected angles and the second angle set includes a number “b” of second uncorrected angles, the electronic device may perform the sinusoidal operation on each of all possible a×b combinations between the first uncorrected angles and the second uncorrected angles, to generate a×b angle pairs, each of which may be adjusted to (or used to generate) a corresponding corrected angle pair by applying the sinusoidal operation to each uncorrected angle pair.

In operation 540, the electronic device may determine matching scores for the respective corrected angle pairs by using a third array (e.g., the third array 33 of FIG. 3 or the third array 43 and/or 44 of FIG. 4) arranged in two dimensions (e.g., a rectilinear arrangement) corresponding to a portion of the virtual MIMO array.

Each matching score may indicate a degree to which the corresponding paired corrected first angle and the corrected second angle reflect an actual position of the corresponding target point.

For example, the first angle set may include “a” first uncorrected angles, and the second angle set may include “b” second uncorrected angles. Since “b” combinations of the “b” second angles are possible for one first angle, “b” angle pairs may be generated for a first uncorrected angle with respect to the target point. The second angle included in an angle pair having a largest matching score among the b angle pairs may most accurately reflect the actual position of the target point at the corresponding first angle. Alternatively, since “a” combinations of the “a” first angles are possible for one second angle, “a” angle pairs may be generated for a second angle with respect to the target point. A first angle included in an angle pair that has the largest matching score among the “a” angle pairs may most accurately reflect the actual position of the target point at the corresponding second angle.

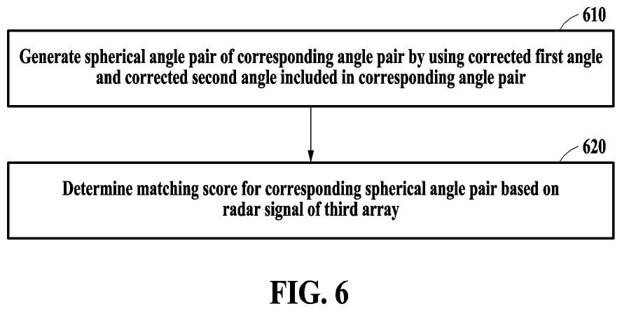

A method of determining matching scores of the respective angle pairs is described in detail with reference to FIG. 6.

In operation 550, the electronic device may generate multi-angle information of the target point based on target angle pairs, among the angle pairs, of which respectively corresponding matching scores satisfy a predetermined criterion.

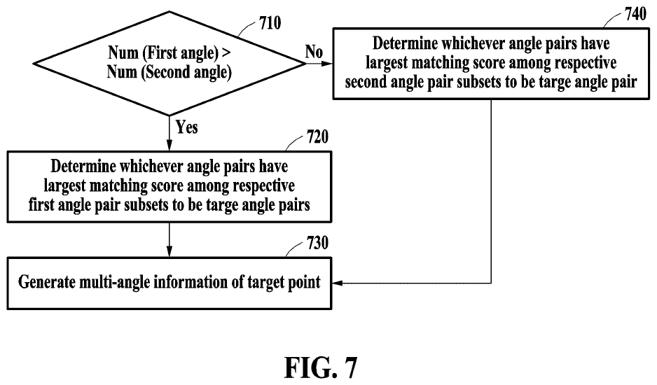

A method of generating the multi-angle information of a target point is described in detail with reference to FIG. 7.

FIG. 6 illustrates an example of a method of determining matching scores of respective angle pairs, according to one or more embodiments.

Operations 610 and 620 described below may be performed by an electronic device (e.g., the electronic device 120 of FIG. 1 or the electronic device 200 of FIG. 2). The electronic device may include at least some of the components of the electronic device 120 or 200 described in FIGS. 1 and 2. For example, the electronic device may include at least one processor (e.g., the at least one processor 210 of FIG. 2), a memory (e.g., the memory 220 of FIG. 2), and a radar sensor (e.g., the radar sensor 130 of FIG. 1 or the radar sensor 230 of FIG. 2). The radar sensor of the electronic device may include an antenna array (e.g., the antenna array 240 of FIG. 2).

As described with reference to FIG. 5, the electronic device may determine a first angle set and a second angle set with respect to a target point (uncorrected angles). The electronic device may generate corrected angle pairs from the uncorrected angle pairs of the target point by performing the predetermined sinusoidal operation on each of the uncorrected angles pairs, which are the possible combinations between the first uncorrected angles of the first angle set and second uncorrected angles of the second angle set.

According to an embodiment, operation 540 of determining matching scores for the respective angle pairs of FIG. 5 may include operations 610 and 620.

In operation 610, the electronic device may generate spherical angle pairs respectively corresponding to the corrected angle pairs by using the corrected first angle and the corrected second angle included in each of the angle pairs with respect to the target point. A spherical angle pair may be expressed as a combination between a third angle and a fourth angle in a spherical coordinate system.

The third angle may be a colatitude (or angle of colatitude). By using the corrected first angle θ_{Azi} and the corrected second angle θ_{Elv} included in a corrected angle pair among the corrected angle pairs, a third angle θ₀ corresponding to the angle pair may be calculated as expressed by Equation 4.

$${θ}_{0} = {cos}^{- 1} \sqrt{\frac{1}{{tan}^{2} {θ}_{A z i} + {tan}^{2} {θ}_{E l v} + 1}} \qquad Equation 4$$

A fourth angle may be a longitude (or angle of longitude). By using the corrected first angle θ_{Azi} and the corrected second angle θ_{Elv} included in a corrected angle pair among the corrected angle pairs, a fourth angle φ₀ corresponding to the corrected angle pair may be calculated as expressed by Equation 5.

$${ϕ}_{0} = \{ \begin{matrix}0 , & for {θ}_{Azi} = 0 , {θ}_{Elv} = 0 \\ \frac{π}{2} , & for {θ}_{Azi} = 0 , {θ}_{Elv} > 0 \\ \frac{π}{2} , & for {θ}_{AZI} = 0 , {θ}_{Elv} < 0 \\ π - {tan}^{- 1} \frac{tan {θ}_{Elv}}{tan {θ}_{Azi}} , & for {θ}_{Azi} > 0 \\ - {tan}^{- 1} \frac{tan {θ}_{Elv}}{tan {θ}_{Azi}} , & for {θ}_{Azi} < 0\end{matrix} \qquad Equation 5$$

In effect, the electronic device may convert the corrected angle pairs with respect to the target point to spherical angle pairs by using Equation 4 and Equation 5.

In operation 620, the electronic device may determine matching scores for the respective spherical angle pairs based on a radar signal (or a radar signal received through a third array) of a third array (e.g., the third array 33 of FIG. 3 or the third array 43 and/or 44 of FIG. 4).

The electronic device may determine/calculate the matching scores for the respectively corresponding spherical angle pairs using a radar signal received through virtual antennas (or virtual antenna elements) of the third array, relative positions of the virtual antennas of the third array, and third and fourth angles included in the spherical angle pairs, to be matching score for the angle pairs.

A matching score for a spherical angle pair (e.g., an ith spherical angle pair) may be calculated as expressed by Equation 6.

$$Matching score ( i ) = \vert {\sum }_{n = 1}^{{N}_{Ant}} {s}_{n} {e}^{j \frac{2 π}{λ} [ {x}_{n} s i n {θ}_{0 , i} cos {ϕ}_{0 , i} + {y}_{n} s i n {θ}_{0 , i} sin {ϕ}_{0 , i} ]} \vert \qquad Equation 6$$

In Equation 6, i denotes an index for the spherical angle pairs (e.g., among a×b spherical angle pairs), N_{Ant} denotes the number of virtual antennas included in the third array used for calculating a matching score, sₙ denotes a reflected radar signal input to an nth (1≤n≤N_{Ant}) virtual antenna, xₙ denotes a relative position of an nth virtual antenna with respect to an x-axis, yₙ denotes a relative position of an nth virtual antenna with respect to a y-axis, λ denotes a wavelength of an operating frequency of the radar sensor, and θ_{0,i} and φ_{0,i} each denote the third angle and the fourth angle of the ith spherical angle pair, respectively.

The electronic device may determine matching scores calculated by Equation 6 for the respective spherical angle pairs (which respectively correspond to the angle pairs) to be the matching scores for the respective angle pairs (each pair including a corrected first angle and a corrected second angle).

FIG. 7 illustrates an example of a method of generating multi-angle information of a target point, according to one or more embodiments.

Operations 710 to 740 described below may be performed by an electronic device (e.g., the electronic device 120 of FIG. 1 or the electronic device 200 of FIG. 2). The electronic device may include at least some of the components of the electronic device 120 or 200 described in FIGS. 1 and 2. For example, the electronic device may include at least one processor (e.g., the at least one processor 210 of FIG. 2), a memory (e.g., the memory 220 of FIG. 2), and a radar sensor (e.g., the radar sensor 130 of FIG. 1 or the radar sensor 230 of FIG. 2). The radar sensor of the electronic device may include an antenna array (e.g., the antenna array 240 of FIG. 2).

As described with reference to FIG. 5, the electronic device may determine a first uncorrected angle set and a second uncorrected angle set with respect to a target point (the target point representative of any number of target points). The electronic device may generate corrected angle pairs with respect to the target point, each corrected angle pair including a corrected first angle and a corrected second angle, by performing a sinusoidal operation on each of the combinations between the first uncorrected angles of the first angle set and each of the second uncorrected angles of the second angle set. The electronic device may determine matching scores the respective corrected angle pairs (and by implication, the uncorrected angle pairs).

In operation 710, the electronic device may compare a number of first angles in the first angle set with a number of second angles in the second angle set. For example, the electronic device may determine whether the number of first angles in the first angle set is greater than (or greater than or equal to) the number of second angles in the second angle set.

According to an embodiment, operation 710 may be performed after operation 520 of determining the first angle set and the second angle set for the target point of FIG. 5. Operation 710 may be performed after operation 530 of generating the angle pairs with respect to the target point of FIG. 5.

Operation 710 may be performed after operation 540 of determining the matching scores for each of the respective corrected angle pairs of FIG. 5. Operation 550 of generating the multi-angle information of the target point of FIG. 5 may include operations 710 to 740.

The electronic device may perform operation 720 when the number of first angles in the first angle set is greater than or equal to (or greater than) the number of second angles in the second angle set. Operation 720 may be performed after operation 540 of determining the matching score for each of the angle pairs of FIG. 5.

In operation 720, the electronic device may determine, to be target angle pairs, whichever angle pairs have the largest matching score among the respective angle pair subsets (angle pair subsets are discussed next). That is, the target angle pairs are the highest scored angle pairs in the respective angle subsets.

An angle pair subset that includes angle pairs of a given first angle (with respect to the target point) may be referred to as a first angle pair subset. For example, with regard to the number of first angle pair subsets, when the first angle set includes “a” first angles and the second angle set includes “b” second angles, the set of all angle pairs may include “a” first angle pair subsets. In this example, since “b” second angles are possible to combine with each first angle (i.e., “b” combinations), each first angle pair subset may include “b” angle pairs. The electronic device may determine, from among the “a” first angle pair subsets, “a” target angle pairs respectively corresponding to the “a” first angle pair subsets, where the angle pair having the largest matching score is selected to be the target angle pair for the corresponding first angle pair subset.

After operation 720, in operation 730, the electronic device may generate multi-angle information of the target point, the multi-angle information including the target angle pairs selected from the angle pair subsets, respectively; in the case of operation 720, the angle pair subsets are the “a” first angle pair subsets.

The electronic device may perform operation 740 instead of operation 720 when the number of first angles in the first angle set is less than (or less than or equal to) the number of second angles in the second angle set. Operation 740 may be performed after operation 540 of determining the matching scores for the respective angle pairs of FIG. 5.

In operation 740, the electronic device may determine target angle pairs to be the target angle pairs having the largest matching score among the respective angle pair subsets.

An angle pair subset that includes angle pairs of a given second angle (with respect to the target point) may be referred to as a second angle pair subset. For example, with regard to the number of second angle pair subsets, when the first angle set includes “a” first angles and the second angle set includes “b” second angles, the angle pairs may include “b” second angle pair subsets. In this example, since “a” first angles are possible to combine with each second angle (i.e., “a” combinations), each second angle pair subset may include “a” angle pairs. The electronic device may determine, from among the “b” second angle pair subsets, “b” target angle pairs respectively corresponding to the “b” second angle pair subsets, where the angle pair having the largest matching score is selected to be the target angle pair for the corresponding second angle pair subset.

After operation 740, in operation 730, the electronic device may generate multi-angle information of the target point, the multi-angle information including the target angle pairs selected from the angle pair subsets, respectively; in the case of operation 740, the angle pair subsets are the “b” second angle pair subsets).

As described above with reference to FIG. 5, each of the angle pairs with respect to the target point may include a corrected first angle and a corrected second angle. The multi-angle information of the target point may include the selected target angle pairs, each having a corrected first angle and a corrected second angle. That is, the multi-angle information of the target point may include information of one or more (corrected) azimuth-elevation pairs of the target point.

The electronic device may generate point cloud data based on the multi-angle information of the target point. As noted above, the point cloud data has numerous uses, for example in autonomous or advanced driving applications, although use of the point cloud data is not limited to these applications.

As described above with reference to FIG. 5, the target point may include range information and velocity information. The electronic device may generate the point cloud data, including range information, velocity information, and information of azimuth-elevation pairs, based on the multi-angle information of the target point. The electronic device may expand a single target point to target points having information of different azimuth-elevation pairs (e.g., target angle pairs).

The electronic device may determine multiple target points by performing range FFT and Doppler FFT, based on a radar signal received through an antenna array of a radar sensor. In other words, the target point may include (or be supplemented by) the multiple additional target points. The electronic device may perform, for each of the target points, determination of a first angle set and a second angle set, generation of angle pairs, determination of a matching score for each of the angle pairs, and generation of multi-angle information (e.g., operations 520 to 550 of FIG. 5). The electronic device may generate the multi-angle information for each of the plurality of target points. The electronic device may generate the point cloud data based on the multi-angle information of each of the plurality of target points.

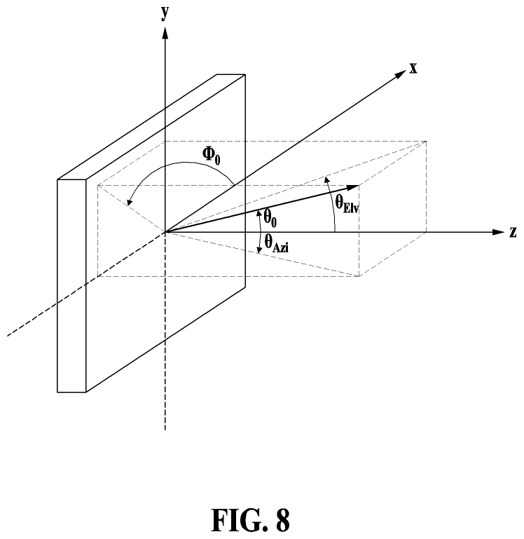

FIG. 8 illustrates an example of a direction of a target point with respect to a coordinate system based on a radar antenna side, according to one or more embodiments.

The radar antenna side may be defined based on a position of a radar sensor (e.g., the radar sensor 130 of FIG. 1 or the radar sensor 230 of FIG. 2).

Referring to FIG. 8, a plane corresponding to the radar antenna side may be defined as an xy plane. An x-axis, which is a reference for measuring longitude (or angle of longitude) in a spherical coordinate system, and a y-axis, which is perpendicular to the x-axis, may each be defined.

A direction perpendicular to the radar antenna side may be defined as a z-axis. The direction perpendicular to the radar antenna side may be a traveling direction of a radar sensor (or an electronic device (e.g., the electronic device 120 of FIG. 1 or the electronic device 200 of FIG. 2) including the radar sensor or a vehicle (e.g., the vehicle 100 of FIG. 1) including the electronic device).

A direction from the electronic device (or radar sensor) to a target point may be referred to as a target direction. A longitude φ₀ in the spherical coordinate system may be defined as an angle between a projection on the xy plane in the target direction and the x-axis. A colatitude (or angle of colatitude) 60 in the spherical coordinate system may be defined as an angle between the target direction and the z-axis.

An azimuth (or angle of azimuth) θ_{Azi} as an angle in a horizontal direction indicated by the target direction may be defined as an angle between a projection on a zx-plane in the target direction and the z-axis. A −x-axis direction may be a positive (+) direction.

An elevation (or angle of elevation) θ_{Elv} as an angle in a vertical direction indicated by the target direction may be defined as an angle between a projection on a yz plane in the target direction and the z-axis. A +y-axis direction may be a positive (+) direction.

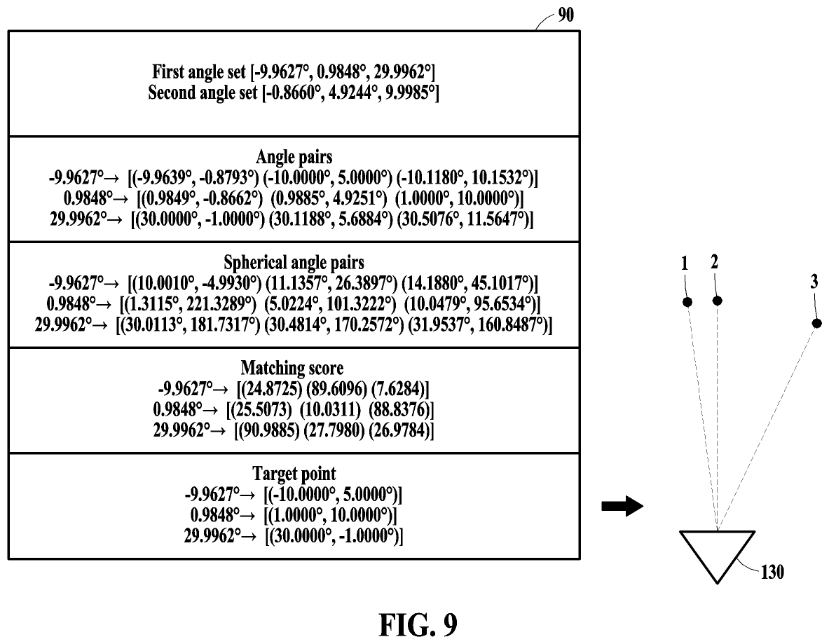

FIG. 9 illustrates an example of generated multi-angle information, according to one or more embodiments.

In table 90 of FIG. 9 is an example of multi-angle information of the target point generated as described with reference to FIGS. 5 to 7.

As described above with reference to FIGS. 5 to 7, an electronic device (e.g., the electronic device 120 of FIG. 1 or the electronic device 200 of FIG. 2) may determine a target point based on a radar signal of an antenna array (e.g., the antenna array 240 of FIG. 2) included in a radar sensor (e.g., the radar sensor 130 of FIG. 1 or the radar sensor 230 of FIG. 2. The electronic device may determine a first angle set for a target point by using a first array (e.g., the first array 31 of FIG. 3 or the first array 41 of FIG. 4) arranged in one dimension in a virtual MIMO array (e.g., the virtual MIMO array 30 of FIG. 3 or the virtual MIMO array 40 of FIG. 4) implemented by an antenna array included in the radar sensor. The electronic device may determine a second angle set for the target point using a second array (e.g., the second array 32 of FIG. 3 or the second array 42 of FIG. 4) arranged in one dimension orthogonal to the first array in the virtual MIMO array.

The first angle set may include one or more first angles. For example, referring to FIG. 9, the first angles of the first angle set may be −9.9627°, 0.9848° and 29.9962°, respectively.

The second angle set may include one or more second angles. For example, referring to FIG. 9, the second angles of the second angle set may be −0.8660°, 4.9244° and 9.9985°, respectively.

The electronic device may generate angle pairs, each angle pair including a corrected first angle and a corrected second angle, by performing a sinusoidal operation on each of the combinations between the first angles of the first angle set and the second angles of the second angle set. The electronic device may generate angle pairs, each including a corrected first angle and a corrected second angle, by performing the sinusoidal operation according to Equation 1 and Equation 2 described with reference to FIG. 5, for all possible combinations (all possible angle pairs) between the first angles of the first angle set and the second angles of the second angle set.

Referring to FIG. 9, the electronic device may generate a total of nine angle pairs, since the first angle set includes three first angles and the second angle set includes three second angles.

For example, −9.9627° among the first angles may be combined with each of the second angles −0.8660°, 4.9244° and 9.9985°, respectively. An angle pair generated by performing the predetermined sinusoidal operation on the first angle θ_{Azi_1D}=−9.9627° and the second angle θ_{Elv_1D}=−0.8660° may include a corrected first angle θ_{Azi}=−9.9639° and a corrected second angle θ_{Elv}=−0.8793°. An angle pair generated by performing the predetermined sinusoidal operation on the first angle θ_{Azi_1D}=−9.9627° and the second angle θ_{Elv_1D}=4.9244° may include a corrected first angle θ_{Azi}=−10.0000° and a corrected second angle θ_{Elv}=5.0000°. An angle pair generated by performing the predetermined sinusoidal operation on the first angle θ_{Azi_1D}=−9.9627° and the second angle θ_{Elv_1D}=9.9985° may include a corrected first angle θ_{Azi}=−10.1180° and a corrected second angle θ_{Elv}=10.1532°. The first angles 0.9848° and 29.9962° may also be combined with the second angles −0.8660°, 4.9244° and 9.9985°, respectively. Since the angle pairs generated for all possible combinations between the first angles and the second angles are described in Table 90, a detailed description related thereto is omitted.

The electronic device may generate a spherical angle pair corresponding to each of the angle pairs by using the corrected first angle and the corrected second angle included in each of the angle pairs with respect to the target point. A spherical angle pair may be expressed as a combination between a third angle and a fourth angle in a spherical coordinate system. The electronic device may convert the angle pairs with respect to the target point to spherical angle pairs by using Equation 4 and Equation 5 described above with reference to FIG. 6.

Referring to FIG. 9, among the angle pairs with respect to the target point, an angle pair (−9.9639°, −0.8793°) including the corrected first angle θ_{Azi}=−9.9639° and the corrected second angle θ_{Elv}=−0.8793° may be converted to a spherical angle pair (10.0010°, −4.9930°). An angle pair (−10.0000°, 5.0000°) may be converted to a spherical angle pair (11.1357°, 26.3897°). An angle pair (−10.1180°, 10.1532°) may be converted to a spherical angle pair (14.1880°, 45.1017°). Since spherical angle pairs corresponding to each angle pair with respect to the target point are listed in order in Table 90, a detailed description thereof is omitted.

The electronic device may determine matching scores for the respective spherical angle pairs (corresponding to each of the angle pairs), and the matching scores may be calculated based on a radar signal (or a radar signal received through a third array) of a third array (e.g., the third array 33 of FIG. 3 or the third array 43 and/or 44 of FIG. 4). The electronic device may calculate the matching scores for the respective spherical angle pairs by using Equation 6 described above with reference to FIG. 7.

Referring to FIG. 9, a matching score of a spherical angle pair (10.0010°, −4.9930°) corresponding to an angle pair (−9.9639°, −0.8793°) may be calculated as 24.8725. A matching score of a spherical angle pair (11.1357°, 26.3897°) corresponding to an angle pair (−10.0000°, 5.0000°) may be calculated as 89.6096. A matching score of the spherical angle pair (14.1880°, 45.1017°) corresponding to the angle pair (−10.1180°, 10.1532°) may be calculated as 7.6284. Since the matching scores of the spherical angle pairs corresponding to each angle pair in Table 90 are listed in order, a detailed description thereof is omitted.

When the number of first angles of the first angle set is greater than or equal to the number of second angles of the second angle set, the electronic device may determine an angle pair having a largest corresponding matching score among each of the angle pair subsets, each of which includes angle pairs generated for each of the first angles among the angle pairs with respect to the target point, to be a target angle pair. An angle pair subset including angle pairs generated for a predetermined first angle with respect to the target point may be referred to as a first angle pair subset.

Referring to FIG. 9, since the first angle set includes three first angles and the second angle set includes three second angles, the angle pairs for the target point may include three first angle pair subsets. Since a combination of three second angles is possible for one first angle, one first angle pair subset may include three angle pairs. For example, a first angle pair subset including angle pairs generated for −9.9627° among the first angles may include the angle pairs (−9.9639°, −0.8793°), (−10.0000°, 5.0000°) and (−10.1180°, 10.1532°). Referring to Table 90, the first angle pair subset including angle pairs generated for each first angle is described in a row of the corresponding first angle.

The electronic device may select, from among the first angle pair subsets, respective angle pairs having the largest matching scores to be the target angle pairs.

Referring to FIG. 9, an angle pair (−10.0000°, 5.0000°) having the largest corresponding matching score in the first angle pair subset including angle pairs generated for −9.9627° among the first angles may be determined to be a target angle pair. An angle pair (1.0000°, 10.0000°) having the largest corresponding matching score in the first angle pair subset including angle pairs generated for 0.9848° among the first angles may be determined to be a target angle pair. An angle pair (30.0000°, −1.0000°) having the largest corresponding matching score in the first angle pair subset including angle pairs generated for 29.9962° among the first angles may be determined to be a target angle pair.

The electronic device may generate multi-angle information of a target point including the target angle pairs selected from the respective angle pair subsets (which, in this example, are the first angle pair subsets). The multi-angle information of the target point may include corrected first angle-corrected second angle pair information corresponding to each of the target angle pairs. That is, the multi-angle information of the target point may be understood as including information of one or more (corrected) azimuth-elevation pairs of the target point.

The electronic device may generate the point cloud data based on the multi-angle information of the target point. As described above with reference to FIG. 5, the target point may include range information and velocity information. The electronic device may generate the point cloud data, including range information, velocity information, and information of azimuth-elevation pairs, based on the multi-angle information of the target point.

The electronic device may expand a single target point to target points having information of different (corrected) azimuth-elevation pairs (e.g., target angle pairs). Referring to FIG. 9, the electronic device may expand a target point to a target point 1 having a target angle pair (−10.0000°, 5.0000°), to a target point 2 having a target angle pair (1.0000°, 10.0000°) and to a target point 3 having a target angle pair (30.0000°, −1.0000°).

The computing apparatuses, the vehicles, the electronic devices, the processors, the memories, the image sensors, the vehicle/operation function hardware, the ADAS/AD systems, the displays, the information output system and hardware, the storage devices, and other apparatuses, devices, units, modules, and components described herein, including descriptions with respect to respect to FIGS. 1-_, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1—that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A method performed by an electronic device, the method comprising:
determining a target point based on a radar signal of an antenna array included in a radar sensor;
determining a first angle set of first angles for the target point by using a first array arranged in a first dimension in a virtual multi-input multi-output (MIMO) array implemented by the antenna array, and determining a second angle set of second angles for the target point by using a second array arranged in a second dimension in the virtual MIMO array, the second dimension orthogonal to the first dimension;
generating angle pairs each comprising a corrected first angle and a corrected second angle, by performing an operation on each of combinations between the first angles and the second angles;
determining matching scores of the respective angle pairs by using a third array that is a portion of the virtual MIMO array, the third array comprising virtual antenna elements arranged in two dimensions; and
generating multi-angle information of the target point based on target angle pairs selected, from among the angle pairs, based on having matching scores that satisfy a criterion.

2. The method of claim 1, wherein the determined target point comprises distance information and velocity information determined by performing a range fast Fourier transform (FFT) and a doppler FFT based on the radar signal.

3. The method of claim 1, wherein the first angle set is determined by performing a one-dimensional direction of arrival (DOA) estimation based on a radar signal of the first array, and
wherein the second angle set is determined by performing a one-dimensional DOA estimation based on a radar signal of the second array.

4. The method of claim 1, wherein each of the first angles is an azimuth, and each of the second angles is an elevation.

5. The method of claim 1, wherein the determining of the matching score for each of the angle pairs comprises:
generating a spherical angle pair of a corresponding angle pair by using the corrected first angle and the corrected second angle included in the corresponding angle pair, wherein the spherical angle pair comprises a third angle and a fourth angle of a spherical coordinate system; and
determining the matching score for the corresponding spherical angle pair based on a radar signal of the third array.

6. The method of claim 5, wherein the third angle is a colatitude, and the fourth angle is a longitude.

7. The method of claim 5, wherein the matching score for the corresponding spherical angle pair is calculated using a radar signal received via the virtual antenna elements of the third array, relative positions of the virtual antenna elements of the third array, and the third angle and the fourth angle included in the corresponding spherical angle pair.

8. The method of claim 1, wherein the generating of the multi-angle information of the target point comprises:
based on the number of first angles being greater than the number of second angles, for angle pair subsets respectively corresponding to the first angles, selecting as the target angle pairs the angle pair in each angle pair subset that has the highest matching score therein, wherein each angle pair subset comprises angle pairs of the corresponding first angle paired with each of the second angles.

9. The method of claim 1, wherein the generating of the multi-angle information of the target point comprises:
based on the number of first angles being less than the number of second angles, for angle pair subsets respectively corresponding to the second angles, selecting as the target angle pairs the angle pair in each angle pair subset that has the highest matching score therein, wherein each angle pair subset comprises angle pairs of the corresponding second angle paired with each of the first angles.

10. The method of claim 1, wherein the electronic device is included in a vehicle.

11. A non-transitory computer-readable storage medium storing instructions,
wherein the instructions, when executed by one or more processors of an electronic device, cause the electronic device to:
determine a target point based on a radar signal of an antenna array included in a radar sensor;
determine a first angle set of first angles for the target point by using a first array arranged in a first dimension in a virtual MIMO array implemented by the antenna array, and determine a second angle set of second angles for the target point by using a second array arranged in a second dimension in the virtual MIMO array, the second dimension orthogonal to the first dimension;
generate angle pairs each comprising a corrected first angle and a corrected second angle, by performing an operation on each of combinations between the first angles and the second angles;
determine matching scores of the respective angle pairs by using a third array that is a portion of the virtual MIMO array, the third array comprising virtual antenna elements arranged in two dimensions; and
generate multi-angle information of the target point based on target angle pairs selected, from among the angle pairs, based on having matching scores that satisfy a criterion.

12. An electronic device, comprising:
one or more processors; and
memory comprising one or more storage media storing instructions that, when executed by the one or more processors, cause the electronic device to:
determine a target point based on a radar signal of an antenna array included in a radar sensor;
determine a first angle set of first angles for the target point by using a first array arranged in a first dimension in a virtual MIMO array implemented by the antenna array, and determine a second angle set of second angles for the target point by using a second array arranged in a second dimension in the virtual MIMO array, the second dimension orthogonal to the first dimension;
generate angle pairs each comprising a corrected first angle and a corrected second angle, by performing an operation on each of combinations between the first angles and the second angles;
determine matching scores of the respective angle pairs by using a third array that is a portion of the virtual MIMO array, the third array comprising virtual antenna elements arranged in two dimensions; and
generate multi-angle information of the target point based on target angle pairs selected, from among the angle pairs, based on having matching scores that satisfy a criterion.

13. The electronic device of claim 12, wherein the determined target point comprises distance information and velocity information determined by performing a range FFT and a doppler FFT based on the radar signal.

14. The electronic device of claim 12,
wherein the first angle set is determined by performing a one-dimensional DOA estimation based on a radar signal of the first array, and
wherein the second angle set is determined by performing a one-dimensional DOA estimation based on a radar signal of the second array.

15. The electronic device of claim 12, wherein each of the first angles is an azimuth, and each of the second angles is an elevation.

16. The electronic device of claim 12, wherein the determining of the matching score for each of the angle pairs comprises:
generating a spherical angle pair of a corresponding angle pair by using the corrected first angle and the corrected second angle included in the corresponding angle pair, wherein the spherical angle pair comprises a third angle and a fourth angle of a spherical coordinate system; and
determining the matching score for the corresponding spherical angle pair based on a radar signal of the third array.

17. The electronic device of claim 16, wherein the third angle is a colatitude, and the fourth angle is a longitude.

18. The electronic device of claim 16, wherein the matching score for the corresponding spherical angle pair is calculated using a radar signal received via the virtual antenna elements of the third array, relative positions of the virtual antenna elements of the third array, and the third angle and the fourth angle included in the corresponding spherical angle pair.

19. The electronic device of claim 12, wherein the corrected first angle and the corrected second angle of each angle pair are determined based the corresponding paired first angle and second angle.

20. The electronic device of claim 19, wherein a sinusoidal operation is performed on the first angle and the second angle to obtain the corrected first angle and the corrected second angle.
